(19) United States
(12) Patent Application Publication
(10) Pub. No.: US 2008/0118412 A1
(43) Pub. Date: May 22, 2008

(54) Coated aluminum material for semiconductor manufacturing apparatus

(75) Inventor: Seiji Okura, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: ASM JAPAN K.K., Tokyo (JP)

(21) Appl. No.: 11/977,315

(22) Filed: Oct. 24, 2007

Related U.S. Application Data
(60) Provisional application No. 60/866,624, filed on Nov. 21, 2006.

(51) Int. Cl. B01J 19/08; B32B 9/04

(52) U.S. Cl. 422/186.21; 428/332

(57) ABSTRACT

A part of a semiconductor-manufacturing apparatus is made of aluminum or an aluminum alloy having a surface coated with a ceramic coating, other than an anodic oxide coating, having a thickness of 10 μm or more.

### CROSS-REFERENCE TO RELATED APPLICATIONS

This application claims the benefit of U.S. Provisional Application No. 60/866,624, filed November 21, and the disclosure of which is herein incorporated by reference in its entirety.

### BACKGROUND OF THE INVENTION

1. Field of the Invention

The present invention generally relates to a semiconductor manufacturing apparatus, particularly to a coated aluminum material used therein.

2. Description of the Related Art

Traditionally semiconductor manufacturing apparatuses use a lot of aluminum or aluminum alloy, and depending on where these materials are used their surface may become vulnerable to corrosion. In particular, parts used in the reaction chamber of a semiconductor manufacturing apparatus corrode easily as a result of physical and chemical reactions.

Accordingly, metals used for these parts are generally given some kind of surface treatment to suppress deterioration of base metal. Among other metals, aluminum lacks corrosion resistance to halogen gases such as fluorine gas and chlorine gas. Therefore, base materials made of aluminum corrode easily due to halogen gases such as fluorine gas and chlorine gas and consequently suffer lower strength or generate particle dust.

If moisture in air enters the apparatus during maintenance, etc., the moisture may react with the halogen gases to produce acid solutions that corrode aluminum.

One representative method that has been traditionally used to prevent aluminum corrosion is to provide anodic oxide coating treatment on aluminum surface. Some oxide coatings provided by anodic oxide coating treatment have been improved to provide greater resistance to cracks under repeated thermal shocks.

### SUMMARY OF THE INVENTION

Despite the aforementioned treatment, however, in an extremely severe environment where the apparatus is exposed to a gas containing fluorine this fluorine enters micro-cracks in the oxide coating and reacts with aluminum to produce aluminum fluoride. This induces separation of oxide coating and the separated coating itself generates particles. Furthermore, on the surface of base aluminum from which the coating has separated, physical and chemical corrosions are promoted. If an acid solution produced by the bonding of fluorine with water enters the cracks in the oxide coating, the base metal may corrode and the same problems caused by aluminum fluoride, such as separated oxide coating, may occur.

As explained above, the conventional anodic oxide coating method is unable to sufficiently protect base metal under certain conditions, in which case deterioration of parts and shortening of their life may result.

In an embodiment, one object of the present invention is to form a ceramic coating on the aluminum or aluminum alloy surface of parts constituting a semiconductor manufacturing apparatus, thereby providing a method to suppress corrosion caused by physical/chemical reactions involving the base metal and extend the life of parts.

In another embodiment, the present invention provides a material for use in the production of semiconductor manufacturing apparatuses, where such material is made by coating with ceramics via the plasma electrolysis method the surface of an aluminum or aluminum alloy material (hereinafter collectively referred to as “aluminum”) used in semiconductor manufacturing apparatuses. Although the methods proposed herein can be applied to any semiconductor manufacturing apparatus parts made of aluminum, it can be favorably applied to the interior parts of the reaction chamber, especially to the electrode materials.

For purposes of summarizing the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description of the preferred embodiments which follow.

### BRIEF DESCRIPTION OF THE DRAWINGS

These and other features of this invention will now be described with reference to the drawings of preferred embodiments which are intended to illustrate and not to limit the invention.

FIG. 1 shows four photographs showing coating surfaces before and after being exposed to a plasma. The upper left photograph shows an initial state of the coating surface of an anodic oxide coating having a thickness of 20 μm. The lower left photograph shows a plasma exposed surface of the anodic oxide coating. The upper right photograph shows an initial state of the coating surface of a ceramic coating having a thickness of 20 μm. The lower right photograph shows a plasma exposed surface of the ceramic coating.

FIG. 2 shows two photographs showing coating surfaces after being exposed to a plasma. The left photograph shows a plasma exposed surface of a ceramic coating having 5 μm. The right photograph shows a plasma exposed surface of a ceramic coating having 20 μm.

### DETAILED DESCRIPTION OF THE PREFERRED EMBODIMENT

The present invention will be explained with reference to preferred embodiments and drawings. However, the preferred embodiments and drawings are not intended to limit the present invention.

In an embodiment, a part of a semiconductor-manufacturing apparatus is made of aluminum or an aluminum alloy having a surface coated with a ceramic coating, other than an anodic oxide coating, having a thickness of 10 μm or more (including 15 μm, 20 μm, 30 μm, 40 μm, 50 μm, 100 μm, and any number between any of the foregoing, preferably 15 μm to 30 μm).

The above embodiment includes, but is not limited to, the following embodiments.

The ceramic coating may be a coating formed by a plasma electrolytic method which may use a water soluble zirconium compound as an electrolyte. In the above, the ceramic coating may contain zirconium oxide and aluminum oxide.

In an embodiment, the part may constitutes a susceptor, a shower plate, and/or an inner wall of a reaction chamber. Typically, the ceramic coating has a rough surface which is rougher than that of an anodic oxide coating. Thus, when the susceptor is coated with the ceramic coating, sticking of a silicon wafer can effectively be inhibited. The susceptor need not be subjected to a special process for making its surface rough.

The part may have higher resistance to a plasma than does an anodic oxide coating.

In an embodiment, a semiconductor-manufacturing apparatus may comprise: a reaction chamber; an upper electrode; and a lower electrode wherein at least one of the foregoing has the ceramic coating on its surface.

As explained above, in an embodiment this ceramic coating is applied on the surface of the lower electrode in a CCP (capacitive coupled plasma) apparatus used in P-CVD. In this case, sticking of Si wafers can be reduced, which in turn reduces the machining processing steps needed to make the surface shape of the lower electrode complex (thereby reducing the contact area). As a result, the steps included the process recipe sequence for the purpose of preventing sticking can be reduced. This helps improve the utilization rate of the apparatus.

In the case of P-CVD, most apparatuses implement plasma cleaning to self-clean the interior of the reaction chamber using plasma containing fluorine. Here, impression of high power increases the cleaning efficiency and improves the utilization rate of the apparatus. However, conventional ceramic coatings and anodic oxide coatings are vulnerable to plasma and thus these coatings separate or cause various other problems when exposed to plasma, especially fluorine plasma, which increases plasma damage to the surface of the electrode. As a result, the electrodes are consumed early and the apparatus downtime increases due to the need to replace the electrodes. In addition, generation of foreign particles reduces the device yield. For these critical defects, conventional coatings are used less frequently in semiconductor manufacturing processes of late. In a specific example involving a Ø300-mm Si wafer processes, conventional coatings cannot be applied to the lower electrode exposed to CCP where self-bias is applied at high temperatures (300 to 450° C.), if voltage of 1 kW or more is impressed during plasma cleaning using CxFy+O₂ gas. In an embodiment of the present invention, at least one of the aforementioned problems can be improved significantly by using a ceramic coating.

To be specific, ceramic coating by the plasma electrolysis method has greater effects when the anode electrode (ground side) of the CCP apparatus is provided as a susceptor heater, and the maximum effects can be achieved in processes that use in-situ plasma cleaning (instead of remote plasma cleaning) where a cleaning gas contains fluorine and/or oxygen is(are) used. Similarly, notable effects can also be expected in processes where in the ICP (inductive coupled plasma) apparatus an electrode receives bias impression and the apparatus is cleaned by in-situ plasma cleaning that uses a gas containing fluorine and/or oxygen.

For your information, the aluminum (or aluminum alloy) to be coated is not specifically limited, and any aluminum can be selected as long as it can be used to construct semiconductor manufacturing apparatuses. Representative materials include 1000 series (pure aluminums), 5000 series (Al—Mg alloys), and 6000 series (Al—Mg—Si alloys).

The ceramic coating can be formed on the surface of aluminum material as a ceramic coating containing zirconium oxide and aluminum oxide, by using an electrolyte containing a water-soluble zirconium compound and setting the plasma electrolysis voltage to a range of 100 to 1,000 V and frequency to a range of 30 to 100 Hz. Furthermore, this coating by the plasma electrolysis method can be implemented by any of the methods disclosed in Published Japanese Translation of PCT International Patent Application No. 2002-508454 and Japanese Patent Laid-open Nos. 2004-278308 and 2006-144574, among others (the disclosure of which is incorporated herein by references in their entirety).

In the present disclosure where conditions and/or structures are not specified, the skilled artisan in the art can readily provide such conditions and/or structures, in view of the present disclosure, as a matter of routine experimentation.

In an embodiment of the present invention, the proposed method can be applied to aluminum parts used in the reaction chamber of a semiconductor manufacturing apparatus, in order to improve their wear resistance, corrosion resistance, heat resistance, peel resistance, etc., and ultimately extend the life of the parts. In another embodiment, the present invention improves the peel resistance to reduce the amount of particles (foreign substance) generated. In yet another embodiment, the present invention reduces particle generation to lower the level of metal contamination of semiconductor devices.

### Example

The surface of a base aluminum material used to produce electrodes for semiconductor manufacturing apparatuses was coated with a ceramic coating containing zirconium oxide and aluminum oxide to a thickness of approx. 20 μm using the plasma electrolysis method (electrolyte=water-soluble zirconium compound; plasma electrolysis voltage=100 to 1,000 V; frequency=30 to 100 Hz). For the purpose of comparison, an anodic oxide coating was formed based on a conventional technology.

To check the effects of these coatings, a plasma exposure test was conducted as an accelerated corrosion test using test chips under the conditions shown in Table 1.

TABLE 1
Plasma Exposure Test Conditions

| Parameters | Set points |
|---|---|
| C₂F₆ | 0.6 SLM |
| O₂ | 1.2 SLM |
| Pressure | 400 Pa |
| RF (13.56 MHz) | 900 W |
| Spacing | 14 mm |
| Temperature | 395° C. |
| Exposure | 10 hours |

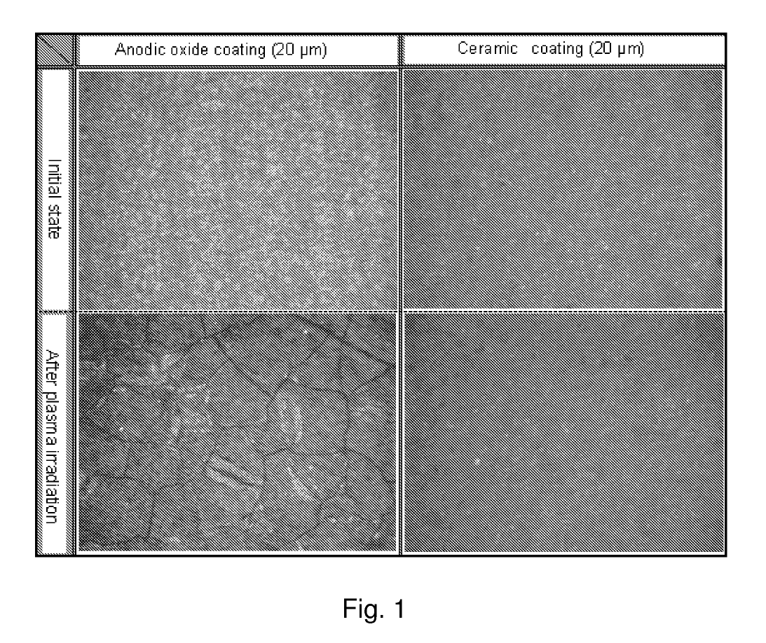

As a result, the oxide coating by the conventional method (photograph at the upper left) generated cracks and partially separated after plasma irradiation (photograph at the lower left), as shown in FIG. 1 (×300). On the other hand, the ceramic coating (photograph at the upper right) showed little change (photograph at the lower right).

These results suggest that the present invention is very effective in treating the surface of electrode parts in semiconductor manufacturing apparatuses. When this method is physically applied to the interior parts of the reaction chamber constituting a semiconductor manufacturing apparatus, it is desirable that the method be applied to the following locations: a. an upper electrode, b. a lower electrode, c. an inner wall of a reaction chamber.

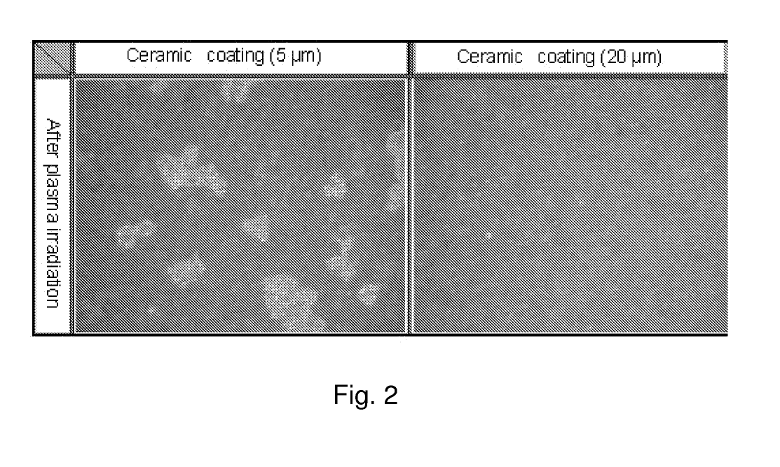

On the other hand, a desired thickness of ceramic coating varies according to the ceramic coating method and plasma exposure test conditions. In this plasma exposure test, whose details are shown in FIG. 2 (×300), evaluation was made based on two ceramic coating thicknesses of 5 μm (photograph on the left) and 20 μm (photograph on the right). Although the evaluation found little change in the thicker coating (20 μm), the thinner coating (5 μm) developed corrosion marks on the surface. This indicates that the ceramic coating under these conditions has notable effects at a thickness of approx. 20 μm.

It will be understood by those of skill in the art that numerous and various modifications can be made without departing from the spirit of the present invention. Therefore, it should be clearly understood that the forms of the present invention are illustrative only and are not intended to limit the scope of the present invention.

What is claimed is:

1. A part of a semiconductor-manufacturing apparatus, which is made of aluminum or an aluminum alloy having a surface coated with a ceramic coating, other than an anodic oxide coating, having a thickness of 10 μm or more.

2. The part according to claim 1, wherein the ceramic coating contains zirconium oxide and aluminum oxide.

3. The part according to claim 1, wherein the ceramic coating is a coating formed by a plasma electrolytic method.

4. The part according to claim 1, which constitutes a susceptor.

5. The part according to claim 1, which constitutes a shower plate.

6. The part according to claim 1, which constitutes an inner wall of a reaction chamber.

7. The part according to claim 1, which has higher resistance to a plasma than does an anodic oxide coating.

8. A semiconductor-manufacturing apparatus comprising:
a reaction chamber;
an upper electrode; and
a lower electrode which is the susceptor of claim 4.

9. A semiconductor-manufacturing apparatus comprising:
a reaction chamber;
an upper electrode which is the shower plate of claim 5; and
a lower electrode.

10. A semiconductor-manufacturing apparatus comprising:
a reaction chamber which has the inner wall of claim 6;
an upper electrode; and
a lower electrode.
